(19) United States
(12) Patent Application Publication
(10) Pub. No.: US 2004/0133433 A1
(43) Pub. Date: Jul. 8, 2004

(54) Method for analyzing and providing of inter-relations between patents from the patent database

(76) Inventors: Young-Gyun Lee, Seoul (KR); Il-Soo Kim, Seoul (KR); Sik Choi, Kyonggi-do (KR); Ji-Rak Jung, Seoul (KR)

Correspondence Address: Paul J Farrell, Dilworth & Barrese, 333 Earle Ovington Boulevard, Uniondale, NY, 11553, US

(21) Appl. No.: 10/398,053

(22) PCT Filed: Mar. 11, 2002
(86) PCT No.: PCT/KR02/00413

(51) Int. Cl. G06F 17/60

(52) U.S. Cl. 705/1

(57) ABSTRACT

The present invention relates to a method for analyzing the mutual citation relationship of the patents, which are desired to be sought from the patent databases having the fields containing the patent information of the prior patents, which were cited by filing a patent application, and relates to a method for providing the analyzed results. At the present invention, the selected patents from the prior patents are distinguished and analyzed according to the one of the three cases: a first case that a user tries to analyze the patents cited as a reference by a target patent at the time of filing, a second case that a user tries to analyze the patents citing the target patent as a reference at the time of filing and a third case that a user tries to analyze the two kinds of patents.

### FIELD OF THE INVENTION

The present invention relates to a method for analyzing the mutual citation relationship of patents to seek from the patent databases having the fields containing the patent information of the prior arts, which were cited by filing a patent application, and relates to a method for providing the analyzed results.

### DESCRIPTION OF THE RELATED ART

As the industry develops, the value of the intellectual properties becomes more and more important and is placed in the position of one of the biggest factors deciding the rise and fall of an enterprise. There are often the cases where one of the largest companies in the world is ruined in a moment only by a few core patents of the competitors, although the company has invested much capital and runs a productive business. Now the holding of intellectual properties have become a unique offensive and defensive measure to survive.

In such an acute situation, each company tries to analyze the intellectual properties of the competitors and to establish its R & D strategy based on the analysis. However, the work requires much time, even though there are generally many excellent patent analysts and patent analysis tools developed by a number of software companies in order to do the work automatically. Most of existing patent analysis tools provide only outward and quantitative analysis information without actually necessary qualitative analysis information. That is, existing analysis tools don't provide the information on how valuable the patents of a company and its competitors are, how likely a company's product is to infringe on his competitors' patents and what strategy may be used to avoid the situation, and how great the possibility of the infringement of the competitors' products to a company's patent is.

### SUMMARY OF THE INVENTION

It is an object of the present invention, which was invented to overcome the above-referenced problems of the prior arts, to provide a method for analyzing the mutual citation relationship between the patents from the patent databases and providing the analyzed results.

### BRIEF DESCRIPTION OF THE DRAWINGS

FIG. 1 illustrates an example of a screen composition of the backward patent analysis according to the present invention.

FIG. 2 illustrates an example of a screen composition, which was fully extended after removing the filtering conditions from FIG. 1 showing a citation tree.

FIG. 3 illustrates an example of a screen composition of the forward patent analysis according to the present invention.

FIG. 4 illustrates an example of a screen composition, which was fully extended after removing the filtering conditions from FIG. 3 showing a citation tree.

FIG. 5 illustrates an example of a screen composition of the collateral patent analysis according to the present invention.

FIG. 6 illustrates an example of a screen composition, which was fully extended after removing the filtering conditions from FIG. 5 showing a citation tree.

### DESCRIPTION OF THE PREFERRED EMBODIMENTS

The present invention to achieve the above objects comprises the steps of:

Inputting at least one (hereinafter we call it ‘patent number’) of the filing number, the publication number and the patent number of a target patent;

as a patent to be analyzed, selecting one of a Backward patent which is cited as a reference of an inputted target patent at the time of patent filing , a Forward patent which is citing the target patent as a reference at the time of patent filing and a Collateral patent which is a patent integrating the Backward patent and the Forward patent;

according to the selection, searching patents that have the patent number of the target patent described directly in the reference-cited field of the prior patent databases (hereinafter called ‘direct-relation patent’) and further searching patents that have the patent number of the searched direct-relation patent described directly in the reference-cited field of the prior patent databases (hereinafter called ‘indirect-relation patent’);

if the Backward patent analysis was selected, generating a citation tree and displaying the citation tree on a specific region of a screen, wherein the citation tree illustrates graphically the relationship between the target patent, the searched direct-relation Backward patents and the searched indirect-relation Backward patents;

if the Forward patent analysis was selected, generating a citation tree and displaying the citation tree on a specific region of a screen, wherein the citation tree illustrates graphically the relationship between the target patent, the searched direct-relation Forward patents and the searched indirect-relation Forward patents;

if the collateral patent analysis was selected, generating a citation tree and displaying the citation tree on a specific region of a screen, wherein the citation tree illustrates graphically the relationship between the target patent, the searched direct-relation Backward patents and the searched indirect-relation Backward patents, and the relationship between the target patent, the searched direct-relation Forward patents and the searched indirect-relation Forward patents;

according to a user's selection, enlarging or reducing at least a portion of the citation tree and displaying the enlarged or reduced citation tree on a screen;

searching further the patents that are directly or indirectly related to the target patent by using one of applicants, inventors, IPC (international patent classification), UPC (U.S. patent classification) and patent registration year, and grouping the further-search results and providing the capability to add their relationship to the citation tree;

according to a user's selection, storing or printing the citation tree displayed on a screen;

according to a user's selection, storing or printing all the searched direct- and indirect-relation patents; and

providing documents or charts to a user after making out documents edited only with the fields selected by a user among bibliographical items as to the stored patents or making out charts about a specific field.

And in case the Backward or the Forward analysis was selected, because there may be many searched direct- and indirect-relation patents, if they are displayed at one time through a citation tree, it is difficult for a user to use the information effectively. Therefore considering such a case it is preferable that the present invention further comprises the steps of:

Selecting the depth (or number of branch relations) of a patent to display on a citation tree at the range of the searched patent, wherein a patent having a direct-relationship with the target patent is defined as ‘depth 1 patent’, and a patent having a direct-relationship with the depth 1 patent is defined as ‘depth 2 patent’; and

notifying the user of the number of the patents corresponding to the selected depth and the estimated time required to generate and display a citation tree, making the user select the number or time, and generating a citation tree according to the user's selection conditions.

Or it is preferable that after searching of the direct- and indirect-relation patent, the present invention comprises further the steps:

filtering the searched direct- and indirect-relation patent by adding conditions about any search field; and

if there are many searched direct- and indirect-relation patents after the filtering and they are displayed at one time through a citation tree, wherein it is difficult for a user to use the information effectively, making a user select the depth of a patent to display on a citation tree at the range of the direct- and indirect-relation patents searched through the filtering.

In addition, the method may include notifying the user of the number of the patents corresponding to the selected depth and the estimated time required to generate and display a citation tree, and making the user select the number or time, whereupon after the user's selection, a citation tree is generated according to the selected conditions.

In addition, the full citation tree may be showed at the removed state of the filtering conditions from the citation tree generated after the filtering according to the user's selection or there may be a capability to change over to the full citation tree without removing the filtering conditions.

In a preferred embodiment of the present invention, in case that the filtered search field is ‘applicant’ (or “assignee” for U.S. Patents, for example) and the filtering condition is that the more the applicant has patent applications or registered patents, the higher the priority for the applicant to be searched is, then the items to be displayed on a screen are classified according to each analysis mode as follows.

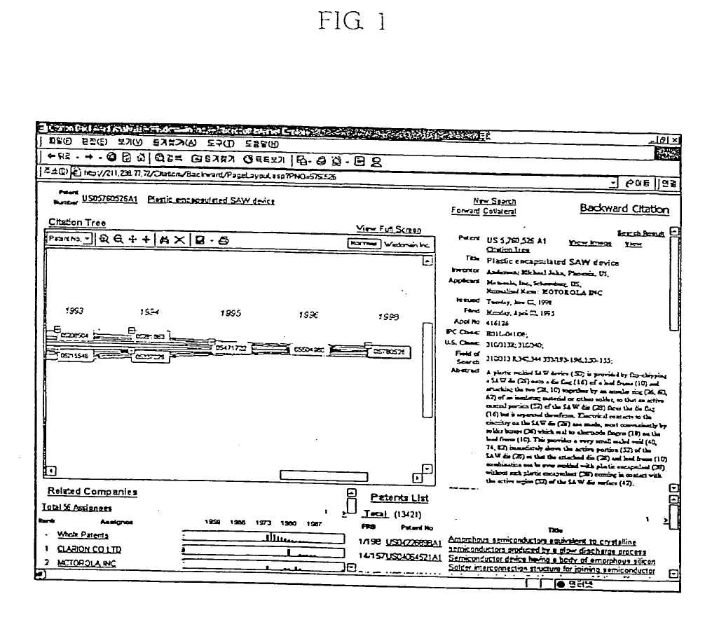

Firstly, FIG. 1 illustrates the Backward patent analysis for a U.S. Pat. No. 5,760,526 as a target patent 10.

As shown in the FIG. 1, the displayed items comprise:

a patent list 11 of all the searched direct- 12 and indirect-relation 14 Backward patents; and

an applicant list 16 sorted in the order of the number of the patent applications or the registered patents of each applicant after counting all the searched direct- and indirect-relation Backward patents as to each applicant.

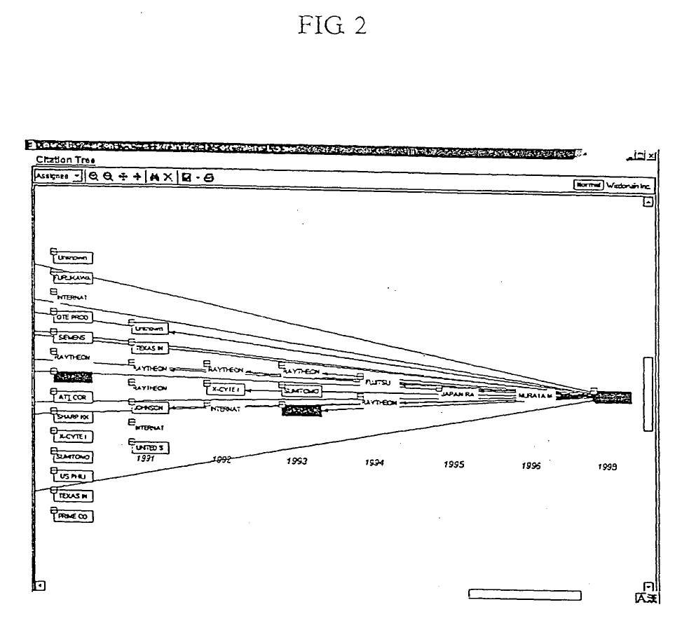

After extracting the data of applicants' ranked 1st, 2nd, and 3rd among the entire data, in order to provide only the core information for a user, a citation tree can be generated illustrating graphically only with the extracted data the relationship between a target patent 10 and the Backward patents 12, 14 and the relationship between the Backward patents 12, 14. FIG. 2 illustrates a citation tree fully expanded after removing the filtering conditions from the citation tree of FIG. 1.

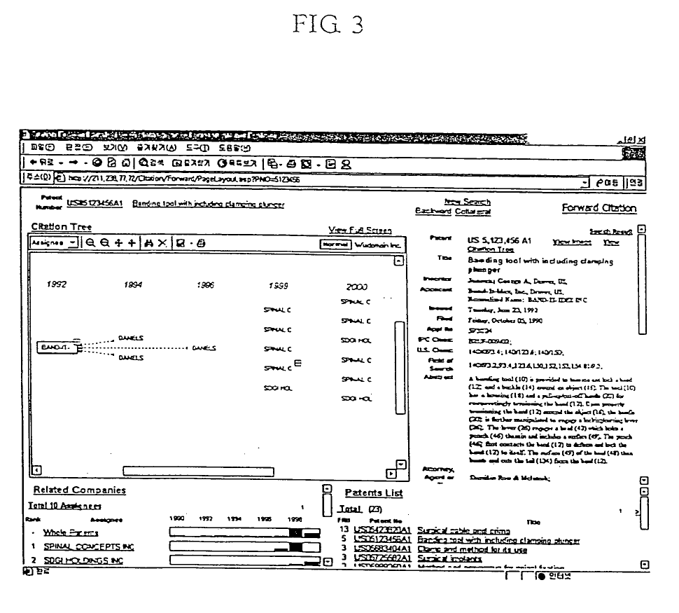

Secondly, FIG. 3 illustrates the forward patent analysis for a U.S. Pat. No. 5,123,456 as a target patent 30.

As shown in the FIG. 3, the displayed items comprise:

a patent list 31 of all the searched direct- 32 and indirect-relation 34 Forward patents; and

an applicant list 36 sorted in the order of the number of the patent applications or the registered patents of each applicant after counting all the searched direct- and indirect-relation Forward patents as to each applicant.

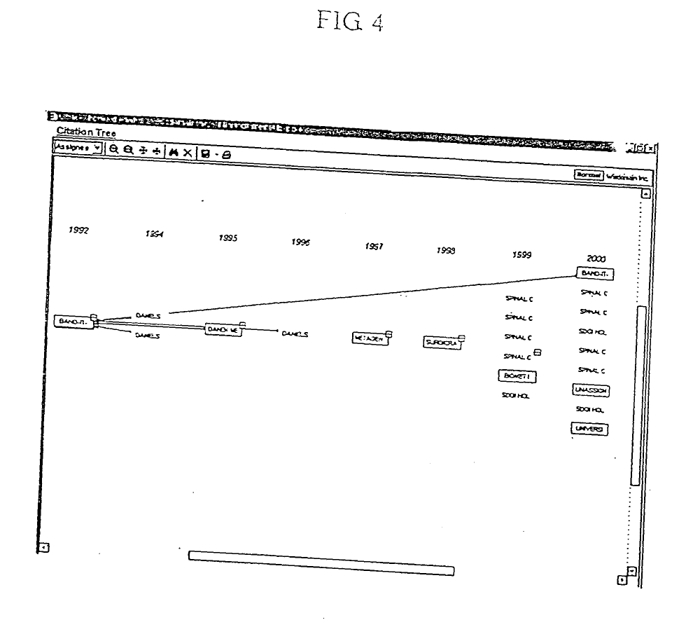

After extracting the data of applicants' only ranked 1st, 2nd, and 3rd among the entire data in order to provide only the core information for a user, a citation tree can be generated illustrating relationships graphically with only the extracted data the relationship between a target patent 30 and the Forward patents 32, 34 and the relationship between the Forward patents 32, 34. FIG. 4 illustrates a citation tree fully expanded after removing the filtering conditions from the citation tree of the FIG. 3.

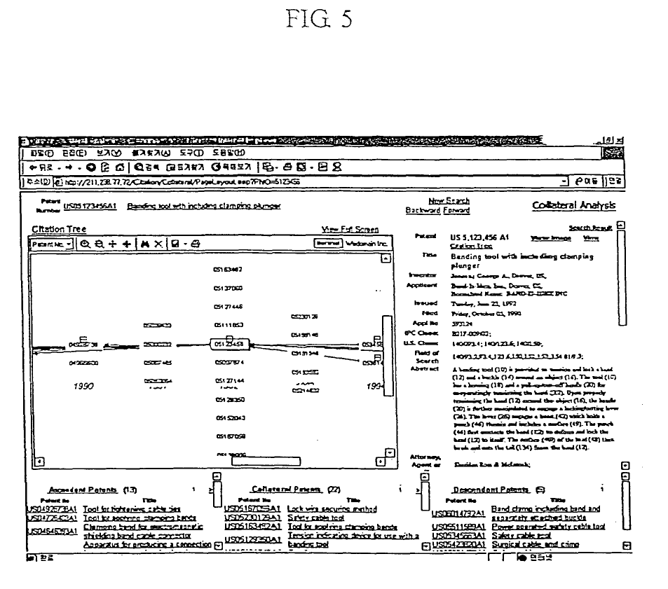

Thirdly, FIG. 5 illustrates the collateral patent analysis for a U.S. Pat. No. 5,123,456 as a target patent 50.

As shown in the FIG. 5, the displayed items comprise:

a patent list 51 of all the searched direct-relation Backward patents 52;

a patent list 53 of all the searched direct-relation Forward patents 54;

a patent list of depth 1 patents and depth 2 patents among the searched indirect-relation Backward 56 and Forward 58 patents, wherein the depth 1 patents have a direct-relationship with a target patent, the depth 2 patents have a direct-relationship with the depth 1 patents.

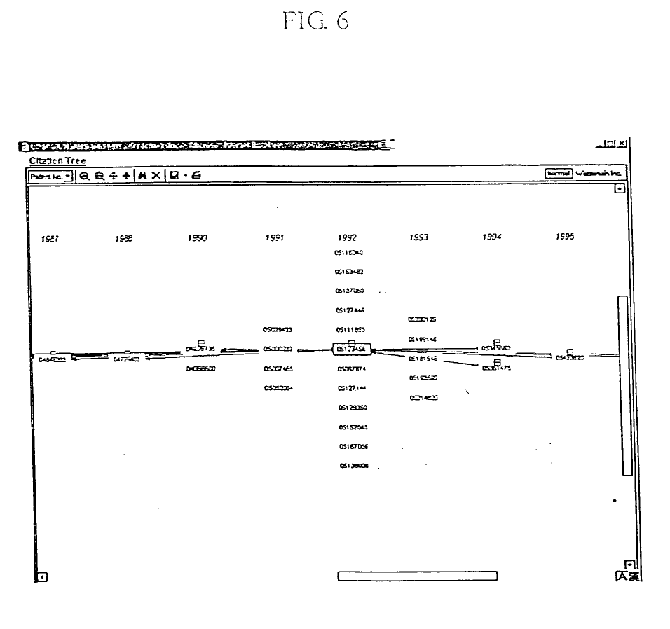

In order to provide only the core information for a user, a citation tree may be generated graphically illustrating the relationship between the depth 1 Backward patents and the Forward patents having direct-relationship with the depth 1 Backward patents, where the depth 1 Backward patents are the Backward patents having the direct-relationship with the target patent centering around the target patent. In addition, the relationship between the depth 1 Forward patents and the Backward patents having direct-relationship with the depth 1 Forward patents may be illustrated, where the depth 1 Forward patents are the Forward patents having the direct-relationship with the target patent on the other side centering around the target patent. FIG. 6 illustrates a citation tree fully expanded after removing the filtering conditions from the citation tree of the FIG. 5.

At the above embodiment, in case that the Backward patent analysis or the Forward patent analysis was selected, if a user selects the data of an applicant ranked 4^{th} and below, the invention generates a citation tree again according to the selection and displays it.

The present invention also comprises generation of a citation tree comprising the steps of:

Sorting firstly the searched patents according to one (hereafter we call it ‘patent year’) of a filing year, a publication year and a registration year of a patent and secondly sorting in the order of the patent number the firstly sorted patents belonging to the same patent year and aligning the sorted patents.

Then, the central coordinate values of the sorted patents (hereafter we call it ‘element’) are allocated on the basis of the sorted positions and the element is displayed on a screen with the allocated coordinate values.

Citation lines are also displayed connecting the central coordinate values between the elements having direct- and indirect-relationship with each other among the elements. The direct-relationship and the indirect-relationship are distinguished by making the type and the color of the lines different. Starting points and the arriving points of the citation lines on the corresponding elements are distinguished according to the cited front and rear relationships for display;

If there are multiple citation relationships and the citation lines overlap, in order to distinguish the citation lines, a virtual circle is generated centering around the central coordinate value of the element corresponding to the starting point of the citation lines. The circumference of the circle is fractioned at predetermined intervals and as for each of the fractioned intervals the starting point of the citation lines is set up differently for display.

If a user changes the displayed conditions, the central coordinate values of each element to be displayed on a citation tree are recalculated according to the changed conditions for display.

At this time, each element to be displayed on a citation tree is displayed by using one of the applicant, the inventor, the UPC, the IPC and the patent year of a corresponding patent. If a mouse pointer is positioned on an element, the bibliographic information of the corresponding patent is displayed.

And also on each element to be displayed on a citation tree, buttons for extension and close are displayed and if a user clicks one of the buttons, an element of a patent having a direct-relationship with the corresponding element is displayed further or the original element is displayed again.

At this time, the extension and the close buttons are displayed by using ‘+’ and ‘−’ and it is possible to display the number of the patents or the number of the citation lines illustrated by extension.

In addition, in the citation tree of the present invention, if a user puts the mouse pointer on each element displayed on the citation tree and clicks the right button of the mouse, then the user can select one of the following six modes of display:

Display the full document of a patent for a corresponding element patent.

2) Emphasize only a patent having a relationship with the corresponding element patent and display it on a citation tree.

Extend or close further a direct-relation patent as to the corresponding element patent on a citation tree.

4) Remove the group to which the corresponding element patent belongs on a citation tree.

5) Combine the patent having the same applicant, inventor, IPC, UPC as the corresponding element patent into the same group and display them together on a citation tree.

Change the corresponding element patent into a new target patent and generate a new Backward-, Forward- or Collateral-citation tree again.

In addition, in order to distinguish the multiple citation lines as to the same element, the circumference of a virtual circle may be fractioned and the fractioned circumference displayed Thus:

A virtual circle centering around the central coordinate values of the element is generated, wherein the circle's area is the same or less than the area of the element displayed on a citation tree.

The virtual circle's circumference is fractioned into 13 intervals and assigning a different citation line to each interval in sequence for display.

If there are more than 13 citation lines, each fractioned interval is sub-fractioned into 3 sub-intervals and a different citation line is assigned to each sub-interval in sequence for display.

Each citation line is made to start from the circumference of the virtual circle, thus making the display begin from the outside of the area occupied by the element.

From the present invention's analysis method, we can get the information of that how the patents of a company and its competitors are valuable, how great the possibility of the infringement of a company's product to the competitors' patents is and what the strategy to avoid them is, and how great the possibility of the infringement of the competitors' products to a company's patent is.

What is claimed is:

1. A method for analyzing the mutual citation relationship between the patents having relation to a target patent, which is to seek from the total prior patent databases having the fields containing the patent information (hereinafter called as ‘reference-cited information’) of the prior patents cited by filing the target patent and providing the analyzed results, said method comprising the steps of:
inputting at least one (hereinafter called as ‘patent number’) of the filing number the publication number and the patent number of a target patent;
as a patent to be analyzed, selecting one of a Backward patent which is cited as a reference by an inputted target patent at the time of patent filing , a Forward patent which is citing the target patent as a reference at the time of patent filing and a Collateral patent which is a patent integrating the Backward patent and the Forward patent;
according to said selection, searching patents that the patent number of the target patent is described directly in the reference-cited field of the prior patent databases (hereinafter called as ‘direct-relation patent’) and further searching patents that the patent number of the searched direct-relation patent is described directly in the reference-cited field of the prior patent databases (hereinafter called as ‘indirect-relation patent’);
in case said Backward patent analysis was selected, generating a citation tree and displaying the citation tree on a specific region of a screen, wherein the citation tree illustrates graphically the relationship between the target patent, the searched direct-relation Backward patents and the searched indirect-relation Backward patents;
in case said Forward patent analysis was selected, generating a citation tree and displaying the citation tree on a specific region of a screen, wherein the citation tree illustrates graphically the relationship between the target patent, the searched direct-relation Forward patents and the searched indirect-relation Forward patents;
in case said Collateral patent analysis was selected, generating a citation tree and displaying the citation tree on a specific region of a screen, wherein the citation tree illustrates graphically the relationship between the target patent, the searched direct-relation Backward patents and the searched indirect-relation Backward patents, and the relationship between the target patent, the searched direct-relation Forward patents and the searched indirect-relation Forward patents;
according to a user's selection, enlarging or reducing the citation tree and displaying said enlarged or reduced citation tree on a screen;
searching further the patents that are directly or indirectly related to the target patent by using one of applicants, inventors, IPC (international patent classification), UPC (U.S. patent classification) and patent registration year, and grouping the further-search results and providing the function to add the relationship of the patents that are directly or indirectly related to the target patent to the citation tree;
according to a user's selection, storing or printing the citation tree displayed on a screen;
according to a user's selection, storing or printing all the searched direct- and indirect-relation patents; and
providing documents or charts to a user after making out documents edited only with the fields selected by a user among the bibliographical items as to the stored patents or making out charts about a specific field.

2. A method as set forth in claim 1, wherein in case the Backward or the Forward analysis is selected, said method further comprises the steps of:
selecting the depth of a patent to display on a citation tree at the range of the searched patent, wherein a patent having a direct-relationship with the target patent is defined as ‘depth 1 patent’, and a patent having a direct-relationship with the depth 1 patent is defined as ‘depth 2 patent’; and
to a user notifying the number of the patents corresponding to the selected depth and the estimated time required to generate and display a citation tree and making the user select one of them, and generating a citation tree according to the user's selection conditions.

3. A method as set forth in claim 1, wherein after searching the direct- and indirect-relation patent, said method further comprises the steps of:
filtering the searched direct- and indirect-relation patent by applying conditions of an arbitrary search field;
considering that if there are many searched direct- and indirect-relation patents after the filtering and they are displayed at one time through a citation tree, it is difficult for a user to use the information effectively, and making a user select the depth of a patent to display on a citation tree at the range of the direct- and indirect-relation patents searched through the filtering;
to a user notifying the number of the patents corresponding to the selected depth and the estimated time required to generate and display a citation tree and making the user select one of the number and the time;
after the user's selection, generating a citation tree according to the selected conditions;
showing the full citation tree at the removed state of the filtering conditions from the citation tree generated after the filtering according to the user's selection or providing a function to change over to the full citation tree at the not-removed state of the filtering conditions.

4. A method as set forth in claim 3, wherein, in case that the filtered search field is ‘applicant’ and the filtering condition is the first, the second, the third ranked applicant having numbers of patent applications or registered patents,
when the Backward patent analysis mode is selected, the items to be displayed on a screen comprise:
a patent list of all the searched direct- and indirect-relation Backward patents;
an applicant list sorted in the order of the number of the patent applications or the registered patents of each applicant after sorting all the searched direct- and indirect-relation Backward patents as to each applicant; and
after only extracting the applicants' data ranked 1st, 2nd, and 3rd among the sorted data, in order to provide only the core information for a user, a citatation tree illustrating graphically only with the extracted data the relationship between a target patent and the Backward patents and the is relationship between the Backward patents,
and when the Forward patent analysis mode is selected, the items to be displayed on a screen comprise:
a patent list of all the searched direct- and indirect-relation Forward patents;
an applicant list sorted in the order of the number of the patent applications or the registered patents of each applicant after sorting all the searched direct- and indirect-relation Forward patents as to each applicant; and
after only extracting the applicants' data ranked 1st, 2nd, and 3rd among the sorted data in order to provide only the core information for a user, a citation tree illustrating graphically only with the extracted data the relationship between a target patent and the Forward patents and the relationship between the Forward patents,
and when the Collateral patent analysis mode is selected, the items to be displayed on a screen comprise:
a patent list of all the searched direct-relation Backward patents;
a patent list of all the searched direct-relation Forward patents;
a patent list of depth 1 patents and depth 2 patents among the searched indirect-relation Backward and Forward patents, wherein the depth 1 patents have a direct-relationship with a target patent, the depth 2 patents have a direct-relationship with the depth 1 patents;
in order to provide only the core information for a user, a citation tree illustrating graphically the relationship between the depth 1 Backward patents and the Forward patents having direct-relationship with the depth 1 Backward patents, wherein the depth 1 Backward patents are the Backward patents having the direct-relationship with the target patent centering around the target patent and illustrating the relationship between the depth 1 Forward patents and the Backward patents having direct-relationship with the depth 1 Forward patents, wherein the depth 1 Forward patents are the Forward patents having the direct-relationship with the target patent on the other side centering around the target patent.

5. A method as set forth in claim 4, wherein in cases that the Backward patent analysis and the Forward patent analysis are selected, if a user selects the data of an applicant ranked 4^{th} and the below ranked applicants too, it is characteristic that said method generates a citation tree again according to the selection and displays said generated citation tree.

6. A method as set forth in any one of claims 1-5, wherein said step to generate a citation tree comprises the steps of:
sorting firstly the searched patents according to one (hereafter called as ‘patent year’) of a filing year, a publication year and a registration year of a patent and secondly sorting in the order of the patent number the firstly sorted patents belonging to the same patent year and aligning the secondly sorted patents;
allocating the central coordinate values of the sorted patents (hereafter we call it ‘element’) on the basis of the sorted positions and displaying the element on a screen with the allocated coordinate values;
further displaying the citation lines connecting the central coordinate values between the elements having the direct- and indirect-relationship with each other among the elements, wherein the direct-relationship and the indirect-relationship are distinguished by making the type and the color of the lines different, and distinguishing the starting points and the arriving points of the citation lines on the corresponding elements according to the cited front and rear relationships and displaying;
in case that there are multiple citation relationships and the citation lines are laid upon each other, in order to distinguish the citation lines, generating a virtual circle centering around the central coordinate value of the element corresponding to the starting point of the citation lines and fractionating the circumference of the circle at the predetermined rate and as for each of the fractionated intervals setting up the starting point of the citation lines differently and displaying; and
in case that a user changes the displayed conditions, re-calculating the central coordinate values of each element to be displayed on a citation tree according to the changed conditions and displaying.

7. A method as set forth in claim 6, wherein it is characteristic that each element to be displayed on a citation tree is displayed by using one of the applicant, the inventor, the UPC, the IPC and the patent year of a corresponding patent and if a mouse pointer is positioned on an element, the bibliographic information of the corresponding patent is displayed.

8. A method as set forth in claim 6, wherein it is characteristic that on each element to be displayed on a citation tree the buttons for extension and close are displayed and if a user clicks one of the buttons, an element of a patent having a direct-relationship with the corresponding element is displayed further or the original element is displayed again.

9. A method as set forth in claim 8, wherein it is characteristic that the extension and the close buttons are displayed by using ‘+’ and ‘−’ and the number of the patents or the number of the citation lines illustrated by extension are displayed.

10. A method as set forth in claim 6, wherein in the citation tree of said method it is characteristic that if a user puts the mouse pointer on each element displayed on the citation tree and clicks the right button of the mouse, then for execution the user can select one of:
a first way to display the full document of a patent as to a corresponding element patent.
a second way to emphasize only a patent having a relationship with the corresponding element patent and display it on a citation tree.
a third way to extend or close further a direct-relation patent as to the corresponding element patent on a citation tree.
a fourth way to remove the group to which the corresponding elements patent belongs on a citation tree.
a fifth way to combine the patent having the same applicant, inventor, IPC, UPC as the corresponding element patent into the same group and display them together on a citation tree.
a sixth way to change the corresponding element patent into a target patent and generate the Backward-, Forward-, Collateral-citation trees again.

11. A method as set forth in claim 6, wherein in order to distinguish the multiple citation lines as to the same element, said step to fractionate the circumference of a virtual circle and to display the fractionated circumference comprises the steps of:
generating a virtual circle centering around the central coordinate values of the element, wherein the circle's area is the same or less than the area of the element displayed on a citation tree;
fractionating the virtual circle's circumference into 13 intervals and assigning a different citation line to each interval in sequence for display;
in case that there are more than 13 citation lines, sub-fractionating each fractionated interval into 3 sub-intervals and assigning a different citation line to each sub-interval in sequence for display; and
making each citation line start from the circumstance of the virtual circle and practically on the citation tree making the display begin from the outside of the area occupied by the element.
